(19) United States
(12) Patent Application Publication
(10) Pub. No.: US 2021/0075999 A1
(43) Pub. Date: Mar. 11, 2021

(54) Automated service storing programmatically via network recording of streaming video and multimedia files generated from smart devices

(71) Applicant: Chang Uk Chung, Mountain House, CA (US)

(72) Inventor: Chang Uk Chung, Mountain House, CA (US)

(21) Appl. No.: 16/563,866

(22) Filed: Sep. 7, 2019

(51) Int. Cl. H04N 5/77; G06F 16/245; G06F 16/23; G06Q 30/02; H04N 7/18

(52) U.S. Cl. CPC H04N 5/77; G06F 16/245; H04N 7/183; G06Q 30/0201; G06F 16/2379

(57) ABSTRACT

A device today can provide to consumers with ease way of recording any images, sequential images inclusive of all type of multimedia formats. These recording can be stored in the device, and/or in cloud storage. However, storing option for smart devices like video bell or indoor/outdoor cameras are restricted by the type of platform and devices. More specific, storing any pertinent log in multimedia format depends and they are limited to plans and pricing offered by the brand only. The novelty of the invention is introducing agnostic modal of storing service, and automatic storage as alternative to the device brand and/or manufacturer by choice of the user.

With the invention remove the dependency that exist on a single business and corporations in large that has control on person's intimate data and user (consumer) lack exposure to critical control at its will.

### FIELD OF THE INVENTION

The invention relates to computer implemented method to automate storage in cloud as service. Storing consist of recording of multimedia files generated from devices in live and/or real time mode.

### BACKGROUND

The surveillance video recording that has multimedia format traditionally has been stored in the device recorder in offline mode. Then with the advance of online modal of storing any kind of files, have exploded significant type of business based on online services. For instance case of the surveillance video recording has moved to alternative mode storing recording in online storage, then as service bundled with the hardware and platform as technology has evolved. With it in the process, alternative has born like door bell video, or same surveillance video for indoor and outdoor that require its multimedia files to stored online, in cloud storage.

These falling into category of home security devices and smart devices, the storage plan and pricing is restricted to the brand and/or manufacturer of the device.

A need therefore exist for consumers to have an alternative that is agnostic of the brand's platform and not tied to its plans and pricing.

### SUMMARY OF THE INVENTION

Embodiments of the invention provide a system that programmatically automate the manual process of capturing screen recording then save via cloud services at the selection by user's preference.

The screen recording of device screen contains multimedia files and video images transmitted and obtained via third party surveillance devices on realtime or deferred mode.

### BRIEF DESCRIPTION OF THE DRAWINGS

FIG. 1 is a flow diagram describing existing process of recording streaming video multimedia files from surveillance devices camera type;

FIG. 2 is a flow chart representing the process of diagram in FIG. 1 and limitation;

FIG. 3 is a flow diagram extension of FIG. 1 with the embodiment;

FIG. 4 is a flow chart representing the process of diagram in FIG. 2 with the embodiment;

FIG. 5 is a flow diagram representing the complete process of FIG. 3 with the embodiment;

FIG. 6 is a flow diagram of implementing the method

### DETAILED DESCRIPTION OF THE INVENTION

While the embodiment can take diverse form as due to numerous variance of combination can exist between devices and user usage behavior, the details in the drawing with its respective specifics are for purpose of exemplary implementation. These description serve as exemplary embodiments only, and not intended to limit the scope of applicability or its configuration potentially might turn as result of the numerous combination. It serves as one form of implementation, and might practiced without some of the specifics.

For case of use case using multiple type of cameras, these are controlled via a system and controlled via visual interface represented in mode of Application for mobile devices and/or web via desktop. The recording of video automatically occur in remote storage upon user has subscribed to plans offered by the same brand or manufacturer, and only and only by the same brand/manufacturer.

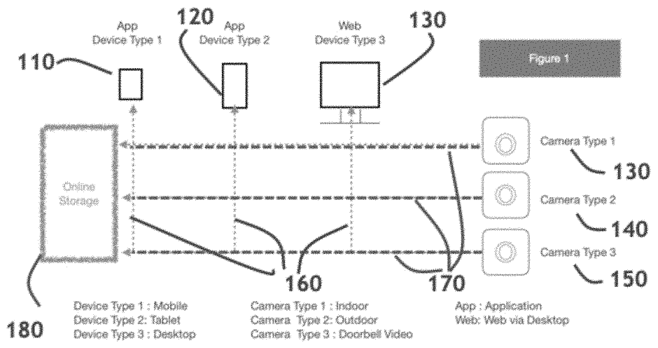

From the FIG. 1 describes flow of the solution described above. User access via device types 110, 120, 130 to view in real time or recorded multimedia files like video. These are recorded via camera types 130, 140,150 via network 160. As user has subscribed plan with provider brand “A” of camera types and system, 170; saved files are recorded via network 160 and stored in server 180, which made available to access to user via device types 110,120, 130.

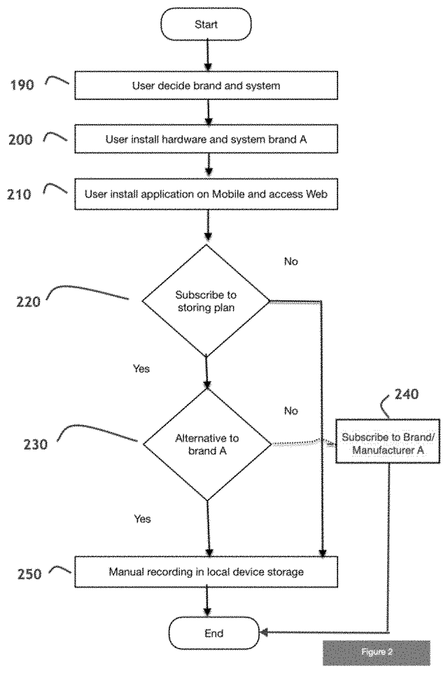

The representation of FIG. 1 being described below in the form of decision chart in FIG. 2. In it, user takes decision on brand and system 190, afterward does installation in process block 200, then setup application and access in process block 210. Then require to subscribe or not in decision block 220. Deciding not to subscribe, user forced to manual recording in local device in process block 250. If decide to subscribe to the brand/manufacturer service in process block 230, it takes to process block 240 where ends with same provider. If looking for alternative as per decision block 230, takes to process block 250.

This embodiment attempt to solve the process block 250 from FIG. 2 of the process of manual recording and storing, which is the constrain of technology and restriction to the purchased brand and system.

The embodiment represent for an end user as consumer, an alternative to selected plan offering from the purchased brand/manufacturer system to record and store automatically by choice on the device or cloud storage.

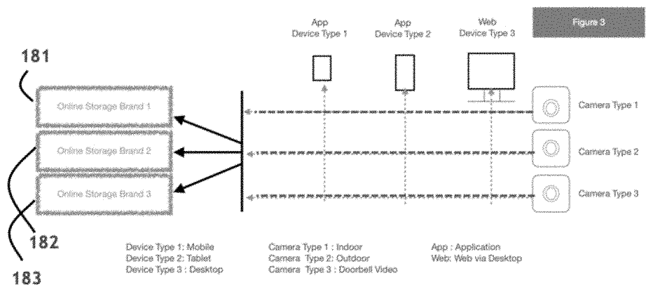

FIG. 3 picture FIG. 1 in which includes the embodiment. For end user having an alternative to storage and plan offered by provider of hardware and manufacture, which can be automated programmatically and store remotely via cloud services, end user can decide to store for price effective provider, blocks number 181, 182, and 183; each can represent brand “B”, brand “C”, and brand “D”.

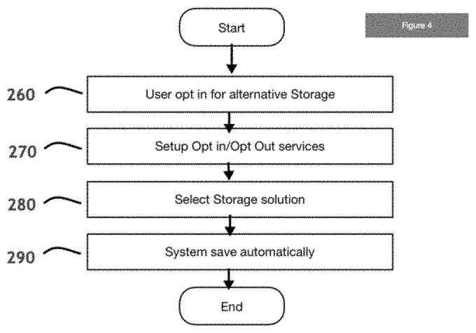

In the same line, the decision chart from FIG. 2 would have extended to aggregated processes to process pictured in FIG. 4. The process block 260 in which end user decide to choose alternative storage plan provider, setup pertinent options with opt in and opt out services on process block 270, select available options of storage on process block 280, then the system save automatically on process block 290.

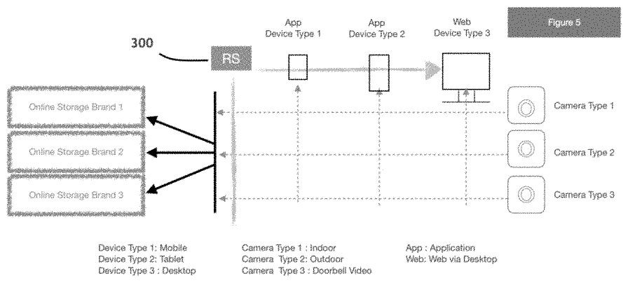

In FIG. 5 represent aggregation to FIG. 3 with the solution, where block 300 represents (RS) Record Screen and Save by the user. The user upon selection of Record Screen, choosing target storage that can be device storage itself and/or to cloud storage different to purchased brand and system. The user interface allowing the process can be via mobile device application and/or web based application for desktop and mobile devices.

The Record Screen and Save (RS), block 300 from FIG. 5, is a function that user decide through the application in mobile or Web to accomplish following manual processes:
1. Recording of the screen view of real time streaming from video camera on mobile device or desktop display;
2. Recording of the screen view of real time streaming from video camera which activation is based on the dynamics like motion detection, or ring door bell that are dependent to the brand/manufacturer system options;
3. The save function works upon recording of screen active then its video and multimedia files when corresponds store in selection of destination storage different to brand/manufacturer systems offering.

To the above list, as part of embodiment extend to the user with further functionalities:
1. Schedule between criteria of range of date and time to record and save;
2. Capability to query and obtain relevant insight based on user defined set of criteria or shared anonymously and published data points allowing to create aggregation to the relevancy.

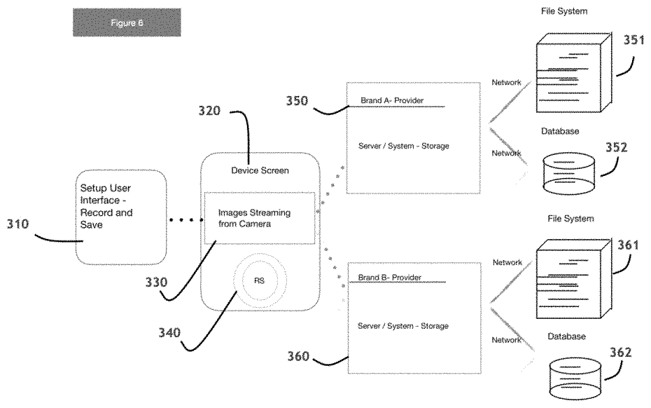

In FIG. 6 depicts the process from user interface to setup to storing it to desired brand/provider of storage. Via user interface 310 user decide 1) to record the device screen in which streamline real time video, 2) target storage of alternative brand/provider 3) user acceptance of integration between camera manufacturer services with alternative provider for user account validation, 4) optional features of extended services like schedule, limit size of file, quality of image. Once the user setting is completed, and under assumption that user has chosen alternative brand/provider for storage, based on this user setting, the system start recording from device screen 320 of image streaming from camera 330 as its recording and saving of files executed 340.

Based upon the brand/provider chosen by user, files can be stored in server 350 for Brand A or server 360 for Brand B. Based on chosen brand/provider, respectively it is stored in file system 351, or organized in table format in data base 352. Respectively, the same if second brand has been chosen, the 361 and 362.

The above described embodiment represents the framework of the invention and exist variance of combinations with addition or substitutions might correspond to achieve the same objective within the scope of the claims except limited by prior arts.

What is claimed is:

1. A method comprising automation of manual steps to record video multimedia files during real time streaming from surveillance video camera and save its files.

2. A method of comprising automation of claim, wherein validate user preferences.

3. A method as recited in claim 2 to pre validate user access and preferences for the purpose.

4. A method as recited in claim 2 to store resulting files in form of data base table.

5. A method as recited in claim 2 to retrieve files via services in organized form.

6. A method as recited in claim 2 to retrieve files based on user request as service.

7. A method comprising automation of claim 1, in which include diverse user setting

8. A method as recited in claim 7 to setup user to select target storage that are online service or local hardware.

9. A method as recited in claim 7 to setup user to user account access validation.

10. A method as recited in claim 7 to setup user to sync user preference with device preference.

11. A method of comprising automation of claim 1, wherein its video multimedia files includes attributes to indicate the context of event.

12. A method as recited in claim 11 to include Date and Time stamp of the recording files based on user personalization and preference setting.

13. A method as recited in claim 11 to include Geolocation data based on user personalization and preference setting.

14. A method as recited in claim 11 to include elements hardware identification by Type, UPC code, serial number, name of device camera, date of purchase, retail name, retail location, and its manufacturer and service provider for streaming.

15. A method of comprising automation of claim 1, wherein its video multimedia files can be organized by user under multiple criteria.

16. A method as recited in claim 15, assigning to each file single or multiple labels in form of tag create by user, and/or created by service provider.

17. A method as recited in claim 15, assigning to each file single or multiple comments and notes.

18. A method as recited in claim 15, assigning to each file permission mode to include and/or not business commercial tag and comments and notes.

19. A method as recited in claim 15, assigning to each file type of significance as Critical, Relevant, Irrelevant, Non Critical, Standard and Activities.

20. A method as recited in claim 15, assigning to each file to make publish and share among groups, selected person, selected geolocation neighbor, selected business organization, selected public organization, private, and delete;

21. A method as recited in claim 15, assigning to each files to group by criteria of date, month, year, days, name of file, tag, shared criteria

22. A method as recited in claim 15, assigning to each files security key by individual files, and group files.

23. A method as recited in claim 15, assigning to each files a log of each action for aforementioned list of user action.

24. A method of comprising automation of claim 1, wherein saved files can be edited or secured not to be edited;

25. A method as recited in claim 24, for edit case create edit activity log.

26. A method as recited in claim 24, for non edit case to create user option by date time stamp.

27. A method of comprising automation of claim 1, wherein saved files in selected storage by user, user can retrieve and organize in the multiple methods.

28. A method as recited in claim 27, create dashboard with data pointers in form of group as action available for user.

29. A method as recited in claim 27, a timeline of files by recording, save date, edit date, date of action of attributes shared, deleted added, duplicated.

30. A method of comprising automation of claim 1, represented in the user interface that fit to device of use.

31. A method of comprising automation of claim 1, wherein to download, distribute via email, and messaging system.

32. A system comprising a cloud server, a local hard drive, a device storage, a device memory, a server cache memory.

33. A computer implemented instructions of claim 1 and claim 9, wherein recorded and saved video multimedia files comprised in part or in all form to delivered as cloud services.

34. A computer implemented instruction of claim 1 and claim 9, wherein user allows its information to be used for commercial business purpose anonymously or by combinations of attributes.
